(19) United States
(12) Patent Application Publication
(10) Pub. No.: US 2020/0305478 A1
(43) Pub. Date: Oct. 1, 2020

(54) STUFFED FRITTER FOODS

(71) Applicant: Stephen Caldwell, Portland, OR (US)

(72) Inventor: Stephen Caldwell, Portland, OR (US)

(21) Appl. No.: 16/363,605

(22) Filed: Mar. 25, 2019

(51) Int. Cl. A23L 19/00; A23L 19/18; A23P 20/25; A23P 30/20; A23L 3/36

(52) U.S. Cl. CPC A23L 19/05; A23L 19/18; A23V 2002/00; A23P 30/20; A23L 3/36; A23P 20/25

(57) ABSTRACT

A method and food product for a stuffed fritter food product. The method or food product may include a first food material formed into a crust with a cavity at a middle portion of the first food material. The method or food product may also include a second food material located within the cavity, where the shredded potato crust has a minimal thickness to contain the second food material and restrict the second food material from leaking outside the shredded potato crust. The crust may be formed by a first nozzle of an extruder device and the second food material may be inserted into the middle portion of the crust by a second nozzle of the extruder device.

### BACKGROUND

Some individuals desire foods with a combination of different flavors and textures. For example, an individual may find the flavor of baked dough filled with a different textured filling to be desirable to their tastes. In another example, an individual may enjoy a smooth and moist filling inside a crispy or flaky dough. Food providers currently offer stuffed or filled food products such as filled pretzels to meet this food desires of customers.

### BRIEF DESCRIPTION OF THE DRAWINGS

The present description will be understood more fully from the detailed description given below and from the accompanying drawings of various embodiments of the present embodiment, which is not to be taken to limit the present embodiment to the specific embodiments but are for explanation and understanding.

FIG. 1 illustrates a cross-sectional view of a stuffed fritter filled with a filling, according to an embodiment.

FIG. 2 illustrates a side perspective view of the stuffed fritter enclosing a liquid or partially liquid filling, according to an embodiment.

FIG. 3 illustrates an extrusion device filling the stuffed fritter with a filling, according to an embodiment.

FIG. 4A illustrates a side perspective view of the stuffed fritter, according to an embodiment.

FIG. 4B illustrates a side view of the stuffed fritter, according to an embodiment.

FIG. 4C illustrates a top view of the stuffed fritter, according to an embodiment.

FIG. 5 illustrates a flowchart of a method to produce the stuffed fritter in FIGS. 1-4C, according to an embodiment.

### DETAILED DESCRIPTION

The disclosed stuffed fritter foods will become better understood through a review of the following detailed description in conjunction with the figures. The detailed description and figures provide merely examples of the various embodiments described herein. Those skilled in the art will understand that the disclosed examples may be varied, modified, and altered and not depart from the scope of the embodiments described herein. Many variations are contemplated for different applications and design considerations; however, for the sake of brevity, the contemplated variations may not be individually described in the following detailed description.

Throughout the following detailed description, examples of various stuffed fritter foods are provided. Related features in the examples may be identical, similar, or dissimilar in different examples. For the sake of brevity, related features will not be redundantly explained in multiple examples. Instead, the use of related feature names will cue the reader that the feature with a related feature name may be similar to the related feature in an example explained previously. Features specific to a given example will be described in that particular example. The reader is to understand that a given feature need not be the same or similar to the specific portrayal of a related feature in any given figure or example.

Conventionally, to prepare a baked potato an individual initially scrubbing the potato skins, removing visible defects in the potatoes by hand, and then bakes the potatoes in their skins at 350° F. for approximately one hour until the potatoes are uniformly baked. The convention method of cooking baked potatoes from fresh raw potatoes is inconvenient and time-consuming. Additionally, individuals desiring foods with a combination of different flavors and textures may desire stuffed or filled potatoes.

One conventional method of making stuffed baked potatoes is known as twice baked potatoes. To prepare the twice baked potatoes, an individual may scoop the inner portion from a previously baked potato, mash it, combine it with milk and butter and other seasonings, and return it to the original potato shells. The filled potato shells are then baked to reheat the potatoes and brown their tops. The twice baked potato may provide different fillings and textures but this process is laborious and time-consuming. Additionally, twice baked potatoes are limited in the types of fillings they may be stuffed with as the fillings are mashed potatoes that are relatively solid material with a minimal amount of liquid. Furthermore, the twice baked potato may not be easily eaten by the individual with their hand or on the go, as the individual must sit down with utensils to eat the twice baked potato.

Implementations of the disclosure address the above-mentioned deficiencies and other deficiencies by providing methods, systems, devices, apparatuses, or foods stuffs that provide a user with a handheld stuffed fritter. In one embodiment, the stuffed fritter may include a shredded potato outer crust with a filling. The stuffed fritter may be partially cooked and then flash frozen. When an individual desires to eat the stuffed fritter, the individual may finish the cooking process by cooking the stuffed fritter in an oven and then eating the stuffed fritter. An advantage of the stuffed fritter may be that is a hand-held snack or meal that may be easily carried around and/or stored by a user. Another advantage of the stuffed fritter may be to provide a hand-held snack or meal that keeps the hands of the individual eating the stuffed fritter relatively clean. Another advantage of the stuffed fritter may be to provide a gourmet eating experience without a sophisticated cooking process and without a labor-intensive process.

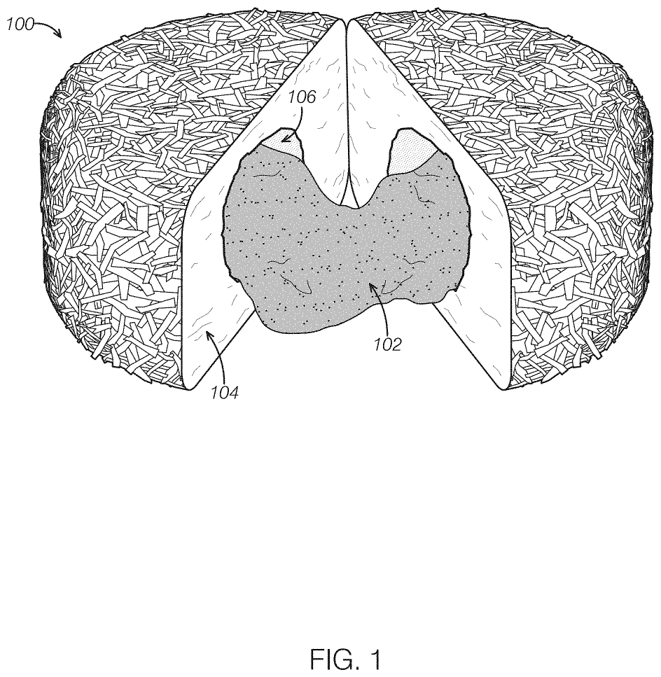

FIG. 1 illustrates a cross-sectional view of a stuffed fritter 100 filled with a filling 102, according to an embodiment. The stuffed fritter 100 may be may be a hand-held foodstuff that includes a crust 104 and a filling 102 contained within the shredded potato crust 104. In one embodiment, crust 104 may include chopped up potatoes, sliced potatoes, or shredded potatoes that are formed into a desired shape. In one example, the crust 104 may include potato material that is parboiled, cut, chilled, and then shredded into potato shreds that are formed into the crust 104.

In one example, the shape of the crust 104 may be a square shape, an oval shape, a disk shape, a puck shape, and so forth. When the crust 103 includes chopped up potatoes, sliced potatoes, or shredded potatoes that are formed into the desired shape, a filling extruder that contains the filling 102 may then be pressed against the crust 104 to insert the filling 102 into a middle of the crust 104 to form a pocket or a cavity 106 within a middle portion or center area of the crust 104 to contain the filling 102.

In one embodiment, for the crust 104 to hold the filling 102, the crust 104 may be a crisp and solid outer shell that is configured to hold the filling 102 in the cavity 106 so that the filling 102 does not leak out while being baked or eaten by an individual. In one example, the crust 104 may be a first type of food material with a first texture and provides a first flavor. In another example, the filling 102 may be a second type of food material with a second texture and provides a second flavor. For example, the crust 104 may be a baked shred potato crust that may provide a crunch potato texture and flavor and the filling may be a cheese filling with a creamy cheese texture and flavor.

In one embodiment, the crust food material may be solid or semi-solid food material. For example, the crust food material may include at least one of potato materials, sweet potato materials, dough, and so forth, In another embodiment, the filling food material may be a solid or semi-solid food material. For example, the filling food material may include potato material, cheese, chili, lentils, curry, vegetables, fruits, cheeses, proteins, spices, meat, and so forth. A food material may be any portion of the food stuff in any edible form. for example, when the food material is a potato material, the potato material may be the potato skin and/or the potato stuffing that may be whole, mashed, sliced, hashed, and so forth.

In one embodiment, the crust 104 may form a solid or semi-solid crust to provide a solid body or housing for an individual to hold in their hand so that while eating the stuffed fritter 100. The solid or semi-solid crust may contain the filling 102 so that as the user eating the stuffed fritter 100 with their hand may keep their hand clean without needing to sit down or use a plate and utensils to eat the stuffed fritter 100. As discussed below, to create the solid or semi-solid crust that encapsulates the liquid or semi-liquid filling, the stuffed fritter 100 may be created using a dual extrusion process to form the crust 104 (such as a shredded potato crust) with the filling 102 fully encapsulated or contained within the crust 104. Once the stuffed fritter 100 is formed using the dual extrusion process, the stuffed fritter 100 may be partially cooked and then flash frozen so that when consumers buy the stuffed fritter 100 from the store, the consumer may finish cooking the stuffed fritter 100 at home in their oven and then eat it.

In one embodiment, the stuffed fritter 100 may be a hand-held sized. For example, the stuffed fritter 100 may be a square shape, a cylindrical shape, a puck shape, or a disk shape. In another example, the stuffed fritter 100 may be approximately one-inch (1″) in height and two inches (2″) in diameter. In another example, the stuffed fritter 100 may vary in size with a ratio of a height half the diameter of the stuffed fritter 100 (height=½ diameter). In another example, the height of the stuffed fritter 100 may range from 0.5″ to 2″ and the diameter may range between 1″ to 4″. In another embodiment, the crust 104 may have a minimum thickness so that the filling 102 within the cavity 106 may stay contained within the cavity 106 during the cooking process and while the consumer eats the stuffed fritter 100. In one example, the crust 104 may be 0.25″ thick and the cavity 106 may be 1.75″ wide for a total diameter of 2″ for the stuffed fritter 100. In another example, a thickness of the crust 104 may range from 0.2″ thick to 1″ thick.

In another example, the thickness of the crust 104 may be uniform or relatively uniform such that the sides, the top, and the bottom of the crust 104 have the same or approximately the same thickness. In another example, the thickness of the top of the crust 104 may be thinner relative to the sides and the bottom of the crust 104 to direct moisture from the filling 102 and/or at least a portion of filling 102 as the filling 102 expands while the stuffed fritter 100 is cooking out the top side of the crust 104. In another example, the crust 104 may have at least a minimum thickness to maintain the structural integrity of the crust 104 while being manufactured, cooked, handled, and/or eaten.

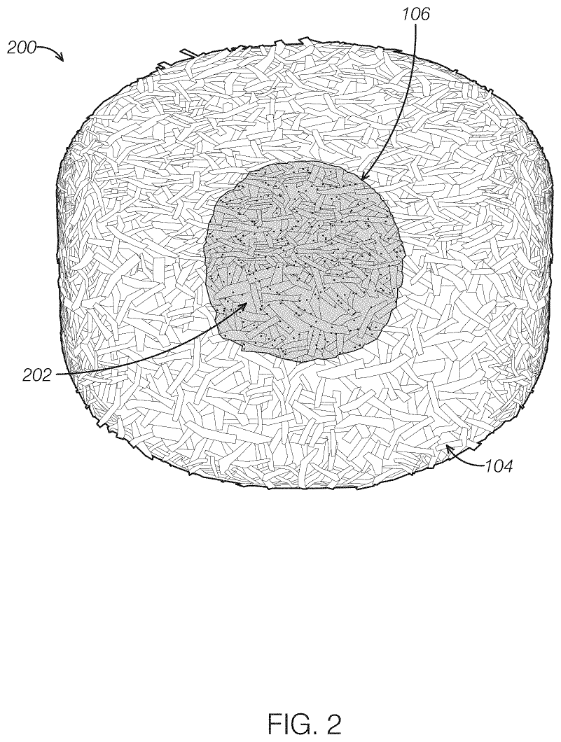

FIG. 2 illustrates a side perspective view of the stuffed fritter 100 enclosing a liquid or partially liquid filling 202, according to an embodiment. Some of the features in FIG. 2 are the same or similar to some of the features in FIG. 1 as noted by same reference numbers, unless expressly described otherwise. As discussed above, the stuffed fritter 100 may include a crust 104 that encloses a filling 102 (as shown in FIG. 1) that is a solid or semi-solid filling in a cavity 106. In another embodiment, the stuffed fritter 100 may include a crust 104 that encloses a filling 202 in the cavity 106.

In one embodiment, the filling 202 may be a liquid food material that may be free flowing. For example, the liquid food material may be milks, sauces, oils, syrups, soups, broths, and so forth. In another embodiment, the filling 202 may be a semi-liquid food material (also referred to as semi-solid food material) that may have properties intermediate between a solid food material and a liquid food material. For example, the semi-liquid food material may be a solid or semi-solid material at a first temperature or temperature range and a liquid material at a second temperature or temperature range. The semi-liquid food material may include butter, chocolate, eggs, batters, cremes, curries, stews, sour cream, cream cheese, chick peas, fig purée, and so forth.

In another embodiment, a thickness of the crust 104 may secure a non-congealed and semi-liquid or liquid filling 202 to restrict or prevent from leaking out of the cavity 106. For example, the semi-liquid or liquid filling 202 may have a lower viscosity level than the filling 102 in FIG. 1. When the filling 202 is mixtured, cooked, and/or heated the viscosity level of the filling 202 may decrease but the crust 104 may continue to restrict or prevent the filling 202 from leaking out of the cavity 106. The crust 104 may enclose a wide range of fillings from liquid fillings 202 to solid filings 102. The types of the crusts 104 and the fillings 102 and/or 202. are not intended to be limiting and may vary. For example, the crusts 104 or the filling 102 and/or 202 may include a single food material or a combination of food materials.

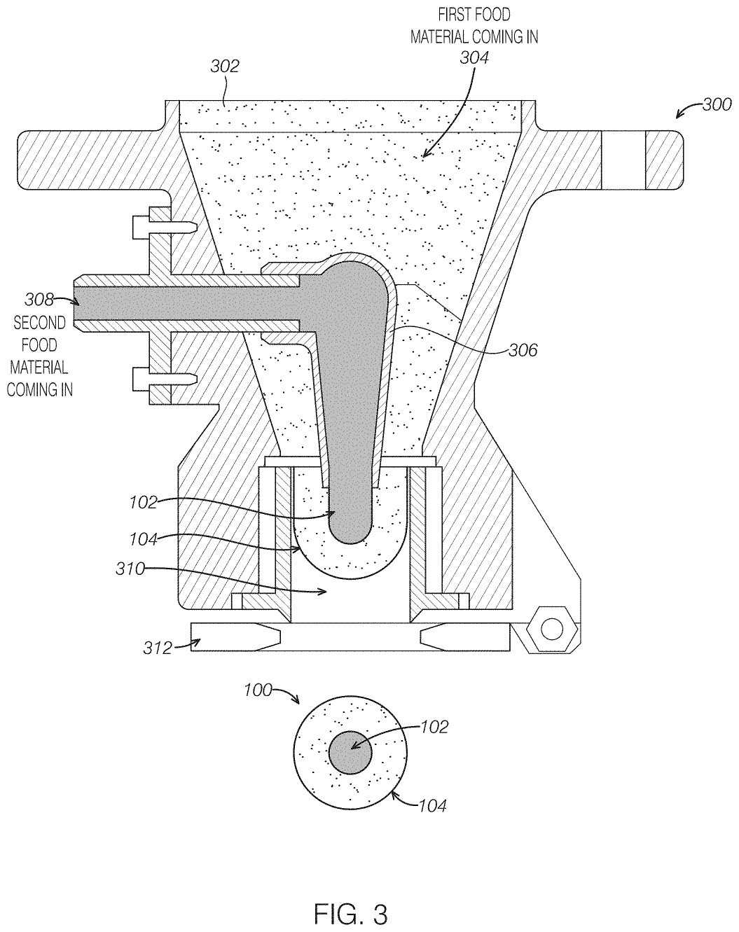

FIG. 3 illustrates an extrusion device 300 filling the stuffed fritter 100 with the filling 102 or the filling 202, according to an embodiment. Some of the features in FIG. 3 are the same or similar to some of the features in FIGS. 1 and 2 as noted by same reference numbers, unless expressly described otherwise. As discussed above, the stuffed fritter 100 may include a crust 104 that may encapsulate or enclose a filling 102 or 202. The extrusion device 300 may be used to form the crust 104 and the filling 102 or 202. In one example, the extrusion device 300 may include a first nozzle 302 and a second nozzle 306. The first nozzle 302 may be a funnel, a faucet, a spout, a conduit, and so forth that may receive a first food material 304. The second nozzle 306 may be a funnel, a faucet, a spout, a conduit, and so forth that may receive a second food material 308.

In one embodiment, the second nozzle 306 may be located within a cavity of the first nozzle 302. The first nozzle 302 may direct the first food material 304 through a spout 310 to form the first food material 304 into a desired shape. In one example, the first nozzle 302. may direct the first food material 304 around the second nozzle 306 as it forms the shape of the first food material 304. As the first food material 304 is directed around the second nozzle 306, the second nozzle may inject the second food material 308 into a center area of the of the first food material 304 so as to form a cavity within the first food material 304 that contains the second food material 308. In one example, as the first food material 304 is directed around the second. nozzle 306, a hollow space or cavity may be formed at the center of the first food material 304 that the second food material 308 may be injected into.

As the first food material 304 is directed through the spout 310 with the second food material 308 at a center of the first food material 304, the spout 310 may form the first food material 304 and the second food material 308 into a desired shape, such as the shape of the stuffed fritter 100 as discussed above. In one example, the spout 310 may have a narrow section to shape the first food material 304 and the second food material 308 into the desired shape as the first food material 304 and the second food material 308 pass through the spout 310.

In one embodiment, the first nozzle 302 may push the first food material 304 through the spout 310 for a first period of time, the first nozzle 302 may push the first food material 304 through the spout 310 and the second nozzle 306 may push the second food material 308 through the spout 310 together for a second period of time, and the first nozzle 302 may push the first food material 304 through the spout 310 for a third period of time so that the spout 310 may eject or discharge the stuffed fritter 100. In this embodiment, the first food material 304 may form the crust 104 in FIGS. 1 and/or 2 and the second food material 308 may be the filling 102 or 202 in FIG. 1 or 2 as discussed above. In another example, the spout 310 may include a shutter 312 that may cut the first food material 304 during the third period of time to complete the shape and structure of the stuffed fritter 100.

In one embodiment, the first food material 304 may be pushed through the first nozzle 302 and/or the second food material 308 may be pushed through the second nozzle 306 by pressure, a vacuum, and so forth. In another embodiment, the first nozzle 302, the second nozzle 306 and/or the spout 310 may heat, cook, or partially cook the first food material 304 and/or the second food material 308 as the first food material 304 and/or the second food material 308 passes through the first nozzle 302, the second nozzle 306, and/or the spout 310, respectively. For example, the first food material 304 and/or the second food material 308 may be heated, cooked, or partially cooked to stabilize the structural integrity of the stuffed fritter 100. For example, when the first food material 304 is heated, cooked, or partially cooked, the first food material 304 may be solidified into a crust to contain the second food material 308 so that the second food material 308 may not leak from the first food material 304. In another example, the first food material 304 and/or the second food material 308 may be heated, cooked, or partially cooked after the first food material 304 and the second food material 308 is formed into the desired shape to stabilize the structural integrity of the stuffed fritter 100 and keep the second food material 308 from leaking from the first food material 304.

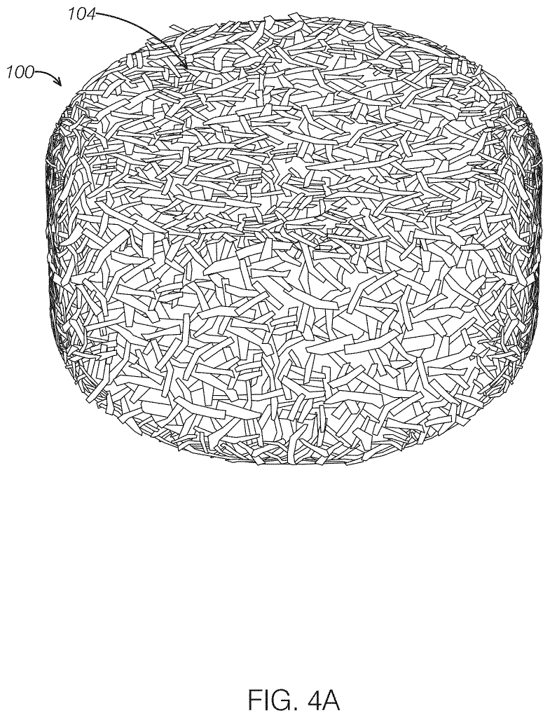

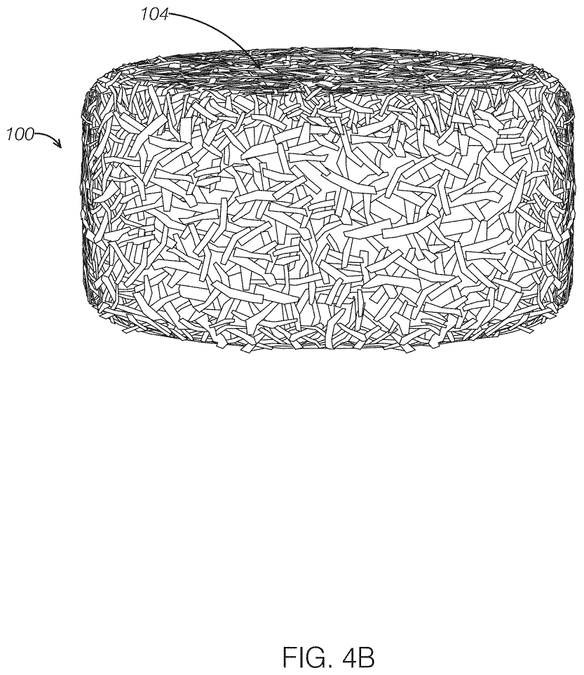

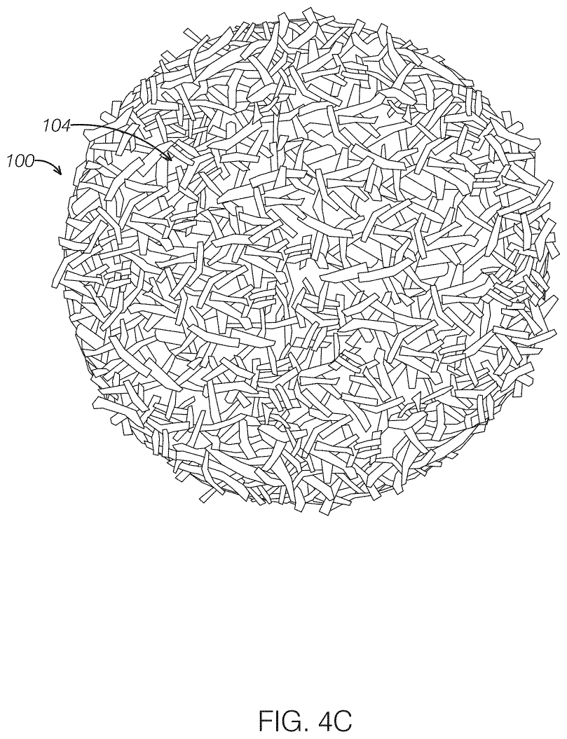

FIG. 4A illustrates a side perspective view of the stuffed fritter 100, according to an embodiment. Some of the features in FIG. 4A are the same or similar to some of the features in FIGS. 1-3 as noted by same reference numbers, unless expressly described otherwise. As discussed above, the stuffed fritter 100 may be a square shape, an oval shape, a disk shape, or a puck shape. FIG. 4A shows a side perspective view of the stuffed fritter 100 with the crust 104 formed in the puck shape.

FIG. 4B illustrates a side view of the stuffed fritter 100, according to an embodiment. Some of the features in FIG, 4B are the same or similar to some of the features in FIGS. 1-4A as noted by same reference numbers, unless expressly described otherwise. FIG. 4B shows a side view of the stuffed fritter 100 with the crust 104 formed in the puck shape.

FIG. 4C illustrates a top view of the stuffed fritter 100, according to an embodiment. Some of the features in FIG. 4C are the same or similar to some of the features in FIGS. 1-4B as noted by same reference numbers, unless expressly described otherwise. FIG. 4C shows a top view of the stuffed fritter 100 with the crust 104 formed in the puck shape.

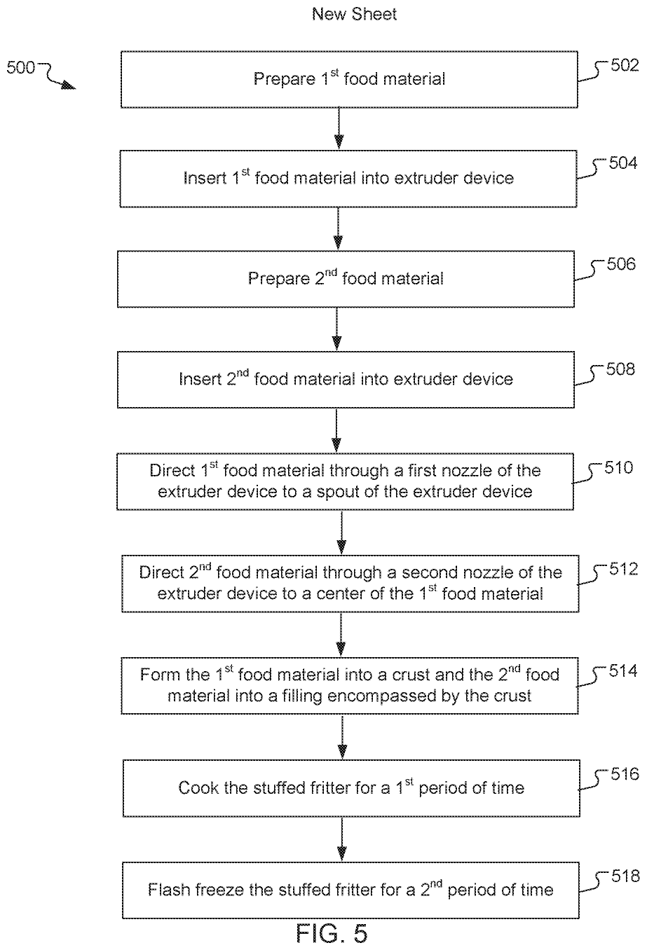

FIG. 5 illustrates a flowchart of a method 500 to produce the stuffed fritter 100 in FIGS. 1-4C, according to an embodiment. The method 500 may include preparing a first food material (block 502). In one example, the first food material may be potatoes. Preparing the potatoes may include parboiling the potatoes for a first threshold amount of time (such as 11 minutes), cooling the potatoes in an ice bath for a second threshold amount of time, shocking or peeling the potatoes, chilling the potatoes, cutting or quartering the potatoes, shredding the potatoes, and/or seasoning the potatoes.

The method 500 may include inserting the first food material into an extruder device (block 504). For example, when the first food material has been prepared, the first food material may be added into a first container, such as a first hopper, of the extruder devices to hold the first food material. The method 500 may include preparing a second food material (block 506). In one example, when the second food material is a mixture of multiple ingredients, the multiple ingredients may be mixed to form the second food material. The method 500 may include inserting the second food material into the extruder device (block 508). For example, when the second food material has been prepared, the second food material may be added into a second container, such as a second hopper, of the extruder device to hold the second food material.

The method 500 may include directing the first food material through a first nozzle of the extruder device to a spout of the extruder device (block 510). The method 500 may include directing the second food material through a second nozzle of the extruder device to the spout of the extruder device (block 512). The method 500 may include forming the first food material into a crust and the second food material into a filling encompassed by the crust (block 514). For example, the first food material may be pushed or directed by a first auger through the first nozzle of the extruder device and the second food material may be pushed or directed by a second auger through the second nozzle of the extruder device. As discussed above, as the first food material is directed toward the spout, the first food material may be directed around the second nozzle such that a cavity may be formed at the center of the first material for the second food material to be inserted into and be fully enclosed by the first food material. The combination of the crust and the filling may be a stuffed fritter.

The method 500 may include cooking the stuffed fritter for a first period of time (block 516). In one example, the stuffed fritter may be placed or dropped onto a conveyor belt from the spout and the stuffed fritter may be immersed in heated oil for a threshold period of time (such as cooking the stuffed fritter for approximately 30 seconds in a highly refined soy oil heated to 350 degrees). In one embodiment, the partially cooked stuffed fritter may then be prepared to be flash frozen by taking the stuffed fritter out of the oil, flow wrapping the stuffed fritter, sealing the stuffed fritters in the wrapping, boxing the stuffed fritters, sealing the box, x-raying the sealed box to ensure the stuffed fritters are properly packed and sealed and free of metal material. The method 500 may include flash freezing the prepared stuffed fritter for a second period of time (block 518).

The above description sets forth numerous specific details such as examples of specific systems, components, methods and so forth, in order to provide a good understanding of several implementations. It will be apparent to one skilled in the art, however, that at least some implementations may be practiced without these specific details. In other instances, well-known components or methods are not described in detail or are presented in simple block diagram format in order to avoid unnecessarily obscuring the present implementations. Thus, the specific details set forth above are merely exemplary. Particular implementations may vary from these exemplary details and still be contemplated to be within the scope of the present implementations.

It is to be understood that the above description is intended to be illustrative and not restrictive. Many other implementations will be apparent to those of skill in the art upon reading and understanding the above description. The scope of the present implementations should, therefore, be determined with reference to the appended claims, along with the full scope of equivalents to which such claims are entitled.

The disclosure above encompasses multiple distinct embodiments with independent utility. While these embodiments have been disclosed in a particular form, the specific embodiments disclosed and illustrated above are not to be considered in a limiting sense as numerous variations are possible. The subject matter of the embodiments includes the novel and non-obvious combinations and sub-combinations of the various elements, features, functions and/or properties disclosed above and inherent to those skilled in the art pertaining to such embodiments. Where the disclosure or subsequently filed claims recite “a” element, “a first” element, or any such equivalent term, the disclosure or claims is to be understood to incorporate one or more such elements, neither requiring nor excluding two or more such elements.

Applicant(s) reserves the right to submit claims directed to combinations and sub-combinations of the disclosed embodiments that are believed to be novel and non-obvious. Embodiments embodied in other combinations and sub-combinations of features, functions, elements and/or properties may be claimed through amendment of those claims or presentation of new claims in the present application or in a related application. Such amended or new claims, whether they are directed to the same embodiment or a different embodiment and whether they are different, broader, narrower or equal in scope to the original claims, are to be considered within the subject matter of the embodiments described herein.

1. A stuffed fritter food product comprising:
a shredded potato crust having a puck shape with a cavity at a mid portion of the shred potato crust, wherein:
a height of the shredded potato crust is within a range of 0.5 inches to 2 inches;
a diameter of the shredded potato crust is within a range of 1 inch to 4 inches; and
the height of the puck-shaped shredded potato crust is half the diameter of the shredded potato crust; and
a filling located within the cavity, wherein:
the filling is a liquid filling or a semi-liquid filling; and
the shredded potato crust has a minimum thickness of at least 0.2 inches to contain the filling and restrict the filling from leaking outside the shredded potato crust.

2. The stuffed fritter food product of claim 1, wherein the minimum thickness of the shredded potato crust is configured to contain the filling within the cavity during at a cooking of the stuffed fritter food product.

3. The stuffed fritter food product of claim 1, wherein the minimum thickness of the shredded potato crust is configured to contain the filling within the cavity while an individual eats the stuffed fritter food product.

4. The stuffed fritter food product of claim 1, wherein:
the cavity is 1.75 inches wide;
the shredded potato crust is 0.25 inches thick; and
a total diameter of the stuffed fritter food product is 2 inches wide.

5. The stuffed fritter food product of claim 1, wherein a thickness of the shredded potato crust is within a range of 0.2 inches to 1 inch.

6. The stuffed fritter food product of claim 1, wherein:
the shredded potato crust is formed by a first nozzle of an extruder device; and
the filling is inserted into the middle portion of the crust by a second nozzle of the extruder device.

7. The stuffed fritter food product of claim 6, wherein the extruder device is configured to direct the shredded potato crust around the second nozzle to form the cavity within shredded potato crust.

8. The stuffed fritter food product of claim 6, wherein the extruder device further comprises a spout to shape the shredded potato crust and filling into the puck shape.

9. The stuffed fritter food product of claim 1, wherein the filling comprises at least one of a potato food material, cheese food material, chili food material, a lentil, curry food material, a vegetable, a fruit, a spice, or a meat food material.

10. The stuffed fritter food product of claim 1, wherein once the stuffed fritter food product is formed by an extruder device then the stuffed fritter food product is partially cooked.

11. The stuffed fritter food product of claim 10, wherein once the stuffed fritter food product is partially cooked then the stuffed fritter food product is flash frozen.

12. A stuffed fritter food product comprising:
a first food material formed into a crust with a cavity at a middle portion of the first food material; and
a second food material located within the cavity, wherein:
the crust has a minimal thickness to:
contain the second food material; and
restrict the second food material from leaking outside the crust;
the crust is formed by a first nozzle of an extruder device; and
the second food material is inserted into the middle portion of the crust by a second nozzle of the extruder device.

13. The stuffed fritter food product of claim 12, where the stuffed fritter food product is a square shape, an oval shape, a disk shape, or a puck shape.

14. The stuffed fritter food product of claim 12, wherein the first food material comprises at least one of a potato food material, a sweet potato food material, a dough food material.

15. The stuffed fritter food product of claim 12, wherein the second food material comprises at least one of a potato food material, cheese food material, chili food material, a lentil, curry food material, a vegetable, a fruit, a spice, or a meat food material.

16. The stuffed fritter food product of claim 12, wherein the second food material is a liquid filling or semi-liquid filling.

17. The stuffed fritter food product of claim 12, wherein:
a height of the crust is within a range of 0.5 inches to 2 inches;
a diameter of the crust is within a range of 1 inch to 4 inches; and
the height of the crust is half the diameter of the crust.

18. A method, comprising:
inserting a first food material into an extruder device;
inserting a second food material into the extruder device;
directing the first food material through a first nozzle of the extruder device to a spout of the extruder device;
directing the second food material through a second nozzle of the extruder device to the spout of the extruder device;
forming the first food material into a crust of a stuffed fritter food product;
forming the second food material into a filling encompassed by the crust; and
partially cooking the stuffed fritter food product for a first period of time.

19. The method of claim 18, comprising flash freezing the stuffed fritter food product for a second period of time.

20. The method of claim 18, wherein the crust has a minimal thickness to contain the filling and restrict the filling from leaking outside the crust.
